(19) United States
(12) Patent Application Publication
(10) Pub. No.: US 2009/0061268 A1
(43) Pub. Date: Mar. 5, 2009

(54) Hydrogen generating apparatus and fuel cell power generation system

(75) Inventors: Jae-Hyoung Gil, Seoul (KR); Jae-Hyuk Jang, Seongnam-si (KR); Chang-Ryul Chang, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/230,328

(22) Filed: Aug. 27, 2008

(30) Foreign Application Priority Data
Aug. 27, 2007 (KR) 10-2007-0086287

(51) Int. Cl. H01M 8/06; C25B 1/02

(52) U.S. Cl. 429/21; 204/230.2

(57) ABSTRACT

A hydrogen generating apparatus according to an embodiment of the invention may include an electrolyte bath, which contains an electrolyte solution, and in an inside surface of which a first groove and a second groove are formed; a first electrode, which is coupled to the first groove with a predetermined distance from either end of the surface of the electrolyte bath, and which is configured to generate electrons; and a second electrode, which is coupled to the second groove with a predetermined distance from either end of the surface of the electrolyte bath, and which is configured to generate hydrogen using the electrons and the electrolyte solution. By using this hydrogen generating apparatus, the volume for holding the fuel can be increased, the gaps between electrodes can be reduced, and the circulation of water can be facilitated to increase the duration of the reactions.

### CROSS-REFERENCE TO RELATED APPLICATIONS

This application claims the benefit of Korean Patent Application No. 10-2007-0086287 filed with the Korean Intellectual Property Office on Aug. 27, 2007, the disclosure of which is incorporated herein by reference in its entirety.

### BACKGROUND

1. Technical Field

The present invention relates to a hydrogen generating apparatus and a fuel cell power generation system.

2. Description of the Related Art

A fuel cell is an apparatus that converts the chemical energies of fuel (hydrogen, LNG, LPG, methanol, etc.) and air directly into electricity and heat, by means of electrochemical reactions. In contrast to conventional power generation techniques, which employ the processes of burning fuel, generating vapor, driving turbines, and driving power generators, the utilization of fuel cells does not entail combustion processes or driving apparatus. As such, the fuel cell is the result of new technology for generating power that offers high efficiency and few environmental problems.

FIG. 1 is a diagram illustrating the operating principle of a fuel cell.

Referring to FIG. 1, a fuel cell 100 may include a fuel electrode 110 as an anode and an air electrode 130 as a cathode. The fuel electrode 110 receives molecular hydrogen (H₂), which is dissociated into hydrogen ions (H⁺) and electrons (e⁻). The hydrogen ions move past a membrane 120 towards the air electrode 130. This membrane 120 corresponds to an electrolyte layer. The electrons move through an external circuit 140 to generate an electric current. The hydrogen ions and the electrons combine with the oxygen in the air at the air electrode 130 to generate water. The following Reaction Scheme 1 represents the chemical reactions described above.

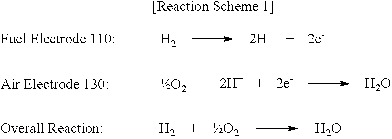

In short, the fuel cell can function as a battery, as the electrons dissociated from the fuel electrode 110 generate a current that passes through the external circuit. Such a fuel cell 100 is a pollution-free power source, because it does not produce any polluting emissions such as SOx, NOx, etc., and produces only little amounts of carbon dioxide. Also, the fuel cell may offer several other advantages, such as low noise and little vibration, etc.

An important task required by the fuel cell is the stable supply of hydrogen. A hydrogen storage tank can be used for this purpose, but the tank apparatus occupies a large volume and has to be kept with special care.

In order for the fuel cell to suitably accommodate the demands in current portable electronic equipment (cell phones, laptops, etc.) for high-capacity power supply apparatus, the fuel cell needs to provide a small volume and high performance.

Thus, a reasonable alternative can be to produce hydrogen using a hydrogen generating apparatus. The hydrogen generating apparatus may convert a regular fuel containing hydrogen atoms into gases containing a large quantity of hydrogen gas, which can then be used by the fuel cell 100.

The fuel cell may employ a method of generating hydrogen after reforming fuel, such as methanol or formic acid, etc., approved by the ICAO (International Civil Aviation Organization) for boarding on airplanes, or may employ a method of using methanol, ethanol, or formic acid, etc., directly as the fuel.

However, the former case may require a high reforming temperature, a complicated system, and high driving power, and is likely to have impurities (e.g. CO₂, CO, etc.) included, besides pure hydrogen. On the other hand, the latter may entail the problem of very low power density, due to the low rate of a chemical reaction at the anode and the cross-over of hydrocarbons through the membrane.

### SUMMARY

An aspect of the invention provides a hydrogen generating apparatus and a fuel cell power generation system, which make it possible to generate pure hydrogen at room temperature using electrochemical reactions, reduce the gaps between the electrodes, and increase the duration of the reactions by facilitating the circulation of water.

Another aspect of the invention provides a hydrogen generating apparatus that includes an electrolyte bath, which contains an electrolyte solution, and in an inside surface of which a first groove and a second groove are formed; a first electrode, which is coupled to the first groove with a predetermined distance from either end of the surface of the electrolyte bath, and which is configured to generate electrons; and a second electrode, which is coupled to the second groove with a predetermined distance from either end of the surface of the electrolyte bath, and which is configured to generate hydrogen using the electrons and the electrolyte solution.

Yet another aspect of the invention provides a fuel cell power generation system that includes a hydrogen generating apparatus and a fuel cell. The hydrogen generating apparatus can include an electrolyte bath, which contains an electrolyte solution, and in an inside surface of which a first groove and a second groove are formed; a first electrode, which is coupled to the first groove with a predetermined distance from either end of the surface of the electrolyte bath, and which is configured to generate electrons; and a second electrode, which is coupled to the second groove with a predetermined distance from either end of the surface of the electrolyte bath, and which is configured to generate hydrogen using the electrons and the electrolyte solution. The fuel cell can be configured to produce a direct electrical current by receiving the hydrogen generated by the hydrogen generating apparatus and converting the chemical energy of the hydrogen into electrical energy.

Certain embodiments of the invention can include one or more of the following features.

The first electrode and the second electrode can be formed with a predetermined distance from an inside surface of the electrolyte bath opposite the first groove and the second groove. The hydrogen generating apparatus can also include a control unit that controls an amount of electrons flowing from the first electrode to the second electrode.

Also, a wire may further be included, which is connected with the first electrode and the second electrode, and which provides a path through which the electrons may travel. Here, the connecting portions between the first and second electrodes and the wire are covered with an insulating material.

A hydrogen outlet can be coupled to an outer side of the electrolyte bath to provide an outlet for discharging the hydrogen.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a diagram illustrating the operational principle of a typical fuel cell.

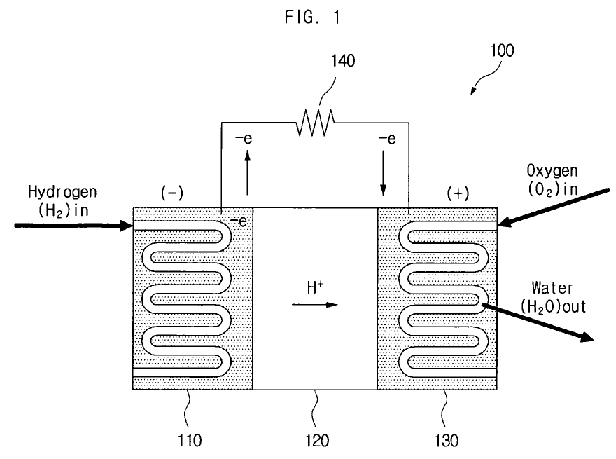

FIG. 2 is a schematic diagram illustrating a hydrogen generating apparatus.

FIG. 3 is a perspective view of an electrolyte bath according to an embodiment of the invention.

FIG. 4 is a perspective view of a hydrogen generating apparatus, in which electrodes are secured to the electrolyte bath of FIG. 3.

FIG. 5 is a schematic diagram illustrating a connecting portion between an electrode and a wire according to an embodiment of the invention.

FIG. 6 is a block diagram of a fuel cell system according to an embodiment of the invention.

### DETAILED DESCRIPTION

As the invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first,” “second,” etc., may be used to describe various elements, such elements must not be limited to the above terms. The above terms are used only to distinguish one element from another.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Certain embodiments of the invention will now be described below in more detail with reference to the accompanying drawings.

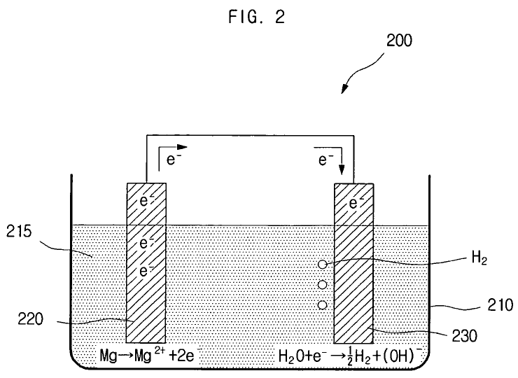

Methods used in generating hydrogen for a polymer electrolyte membrane fuel cell (PEMFC) can be divided mainly into methods that use the oxidation of aluminum, methods that use the hydrolysis of metal borohydrides, and methods that use reactions on metal electrodes. Among these methods, methods of using metal electrodes can be more advantageous in terms of efficiently adjusting the rate of hydrogen generation. FIG. 2 is a schematic diagram illustrating a hydrogen generating apparatus that uses metal electrodes.

In the illustrated drawing, an anode 220 made of magnesium and a cathode 230 made of stainless steel are dipped in an electrolyte solution 215 inside an electrolyte bath 210.

The basic principle of the hydrogen generating apparatus 200 is that electrons are generated at the magnesium electrode 220, which has a greater tendency to ionize than the stainless steel electrode 230, and the generated electrons travel to the stainless steel 230 electrode. The electrons can then react with the aqueous electrolyte solution 215 to generate hydrogen.

This is a method in which the electrons obtained when magnesium in the electrode 220 is ionized to Mg²⁺ ions are moved through a wire and connected to another metal object (e.g. aluminum or stainless steel), where hydrogen is generated by the dissociation of water. The amount of hydrogen generated can be adjusted on demand, as it is correlated to the flow or cut-off of electricity, the distance between electrodes, and the sizes of the electrodes.

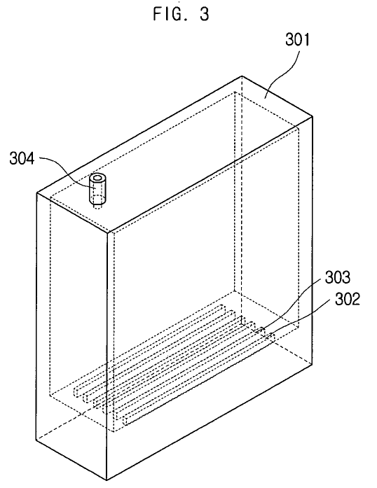

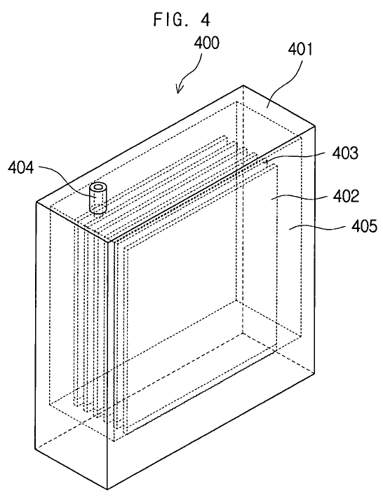

FIG. 3 is a perspective view of an electrolyte bath according to an embodiment of the invention, and FIG. 4 is a perspective view of a hydrogen generating apparatus, in which electrodes are secured to the electrolyte bath of FIG. 3.

The hydrogen generating apparatus 400 can include an electrolyte bath 301, 401, first grooves 302, second grooves 303, a hydrogen outlet 304, 404, first electrodes 402, second electrodes 403, and an electrolyte solution 405.

For better understanding and easier explanation, the following description will focus on an example configuration in which the first electrodes 402 are made of magnesium (Mg) and the second electrodes 403 are made of stainless steel.

The electrolyte bath 401 may contain an electrolyte solution 405 inside. The electrolyte solution 405 may include hydrogen ions, which can be used by the hydrogen generating apparatus 400 to generate hydrogen gas.

Compounds such as LiCl, KCl, NaCl, KNO₃, NaNO₃, CaCl₂, MgCl₂, K₂SO₄, Na₂SO₄, MgSO₄, AgCl, etc., can be used as the electrolyte in the electrolyte solution 405.

A first groove 302 can be formed in a bottom surface inside the electrolyte bath 301, in a position separated from either end of the bottom surface by a predetermined distance. The first groove 302 may serve to secure the first electrode 402, which generates electrons.

Also, a second groove 303 can be formed adjacent to and parallel to the first groove 302, in a position separated from either end of the bottom surface by a predetermined distance. Of course, multiple grooves can be formed parallel to one another in one surface. The second groove 303 may serve to secure the second electrode 403, which generates hydrogen using the electrons and the electrolyte solution 405.

In other words, the first groove 302 and second groove 303 can serve to secure the first electrode 402 and second electrode 403 described later. The lengths, widths, and depths of the first and second grooves 302, 303 can be altered according to the sizes of the electrodes used. As illustrated in FIG. 4, the first and second electrodes 402, 403 can be secured in the first and second grooves 302, 303 formed in the bottom portion of the electrolyte bath 401, obviating the need to fabricate separate guides for securing the electrodes 402, 403.

As such, with this embodiment, it is not necessary to fabricate separate protruding guides for securing the first and second electrodes 402, 403 inside the electrolyte bath 401. Since the increase in volume, which may otherwise result from using the conventional protruding guides, can be avoided, the space for holding the fuel, i.e. the water, can be increased.

The first groove 302 and second groove 303 formed in an inside surface of the electrolyte bath 401 can be formed with a predetermined distance from either end of the bottom surface. Therefore, as illustrated in FIG. 3 and FIG. 4, the first and second electrodes 402, 403 secured in the first and second grooves 302, 303 can be formed with a predetermined distance from each side surface. This structure facilitates the circulation of the fuel, i.e. the water, using the spaces in both sides, so that the water may better circulate around the first and second electrodes 402, 403.

In the related art, Mg(OH)₂, which is a by-product of the reactions, may absorb the water around the electrodes, so that the circulation of water may be hindered and the duration of the reactions may be shortened.

In this embodiment, the circulation of water can be facilitated, due to the space in either side of the first and second electrodes 402, 403, so that the reaction times can be prolonged.

Another possible advantage provided by this embodiment is that the gaps between first grooves 302 and second grooves 303 can be decreased, to minimize the distances between first electrodes 402 and second electrodes 403. Minimizing the distance between the first electrodes 402 and second electrodes 403 makes it possible to form a greater number of electrodes for the same volume of the electrolyte bath 401, so that a larger amount of hydrogen may be generated. That is, the number of electrodes can be increased, and the gaps between electrodes can be reduced, so that consequently, the hydrogen generating apparatus 400 can be given a more compact size.

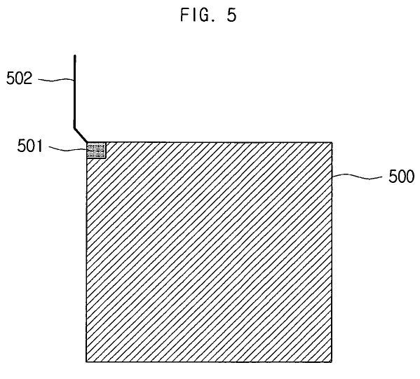

When the gaps between electrodes are minimized, however, the gaps between the anodes 402 and cathodes 403 may be minimized, leading to a risk of short-circuiting. This risk can be prevented by coating an insulating material 501 over the connecting portion between each of the electrodes 500 and the corresponding wire 502, as illustrated in FIG. 5. Of course, an insulating tape can be used for the insulating material 501.

Here, it is apparent that the electrode 500 is one of the first electrodes 402 and second electrodes 403 illustrated in FIG. 4.

As an anode 402 and a cathode 403 come into contact with each other, the insulated material 501 may come into contact first, because the insulated portions will protrude from the electrodes 500. In this way, contact between the electrodes 500 can be avoided, and the risk of short-circuiting can be prevented.

The first electrode 402 can be the active electrode. In cases where the first electrodes 402 are made of magnesium (Mg), the magnesium (Mg) can release electrons and be oxidized into magnesium ions (Mg²⁺), due to the difference in ionization energy between magnesium and water (H₂O). The electrons thus generated in a first electrode 402 may travel through a wire to a control unit, and then through a wire to a second electrode 403. As such, the first electrodes 402 may be expended in accordance with the electrons generated, and may be replaced after a certain period of time. The first electrodes 402 can be made of a metal having a greater tendency to ionize than the material used for the second electrodes 403.

The second electrode 403 can be formed adjacent to and parallel to the first electrode 402. The second electrodes 403 can be coupled to the second grooves 303 to be formed with predetermined distances from either end of the bottom surface of the electrolyte bath 401. The second electrodes 403 can generate hydrogen using the electrons and the electrolyte solution 405. The hydrogen can then be discharged through a hydrogen outlet 404 coupled to an outer side of the electrolyte bath 401.

The second electrode 403 can be the inactive electrodes. The second electrodes 403 can receive the electrons that have traveled from the first electrodes 402, to react with the electrolyte solution 405 and generate hydrogen.

Since the second electrodes 403 may be inactive electrodes and may not be expended, unlike the first electrodes 402, the second electrodes 403 can be made thinner than the first electrodes 402.

Looking at the chemical reactions involved at the second electrode 403, water may be dissociated at the second electrode 403 after receiving the electrons from the first electrode 402, whereby hydrogen may be generated.

The reaction above can be represented by the following Reaction Scheme 2.

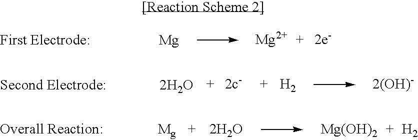

The rate and efficiency of the chemical reactions described above are determined by a number of factors. Examples of factors that determine the reaction rate include the areas of the first electrodes 402 and/or the second electrodes 403, the concentration of the electrolyte solution 405, the type of the electrolyte solution 405, the number of first electrodes 402 and/or second electrodes 403, the method of connection between the first electrodes 402 and the second electrodes 403, and the electrical resistance between the first electrodes 402 and the second electrodes 403, etc.

Changes in the factors described above can alter the amount of electric current (i.e. the amount of electrons) flowing between the first electrode 402 and second electrode 403, whereby the rate of the electrochemical reaction represented in Reaction Scheme 2 may be changed. A change in the rate of the electrochemical reaction will result in a change in the amount of hydrogen generated at the second electrode 403.

Thus, in embodiments of the invention, it is possible to adjust the amount of hydrogen generated, by adjusting the amount of electric current flowing between the first electrodes 402 and the second electrodes 403. The underlying principle of this can be explained by the following Equation 1 using Faraday's law.

$${N}_{hydrogen} = \frac{i}{nE} \\ {N}_{hydrogen} = \frac{i}{2 \times 96485} ( mol ) \\ \begin{matrix}{V}_{hydrogen} = \frac{i}{2 \times 96485} \times 60 \times 22400 ( ml \text{/} min ) \\ = 7 \times i ( ml \text{/} min )\end{matrix} \qquad [ Equation 1 ]$$

Here, N_{hydrogen} represents the amount of hydrogen generated per second (mol/sec), and V_{hydrogen} represents the volume of hydrogen generated per minute (ml/min). i represents current (C/s), n represents the number of reacting electrons (mol), and E represents the charge per one mole of electrons (C/mol).

With reference to Reaction Scheme 2 described above, as two electrons react at the second electrode 403, n equals 2, and the charge per one mole of electrons is about −96,485 coulombs.

The volume of hydrogen generated in one minute can be calculated by multiplying the amount of hydrogen generated in one second by the time (60 seconds) and the volume of one mole of hydrogen (22,400 ml).

If the fuel cell is used in a 2 W system, the required amount of hydrogen may be about 42 ml/mol, and 6 A of electric current may be needed. If the fuel cell is used in a 5 W system, the required amount of hydrogen may be about 105 ml/mol, and 15 A of electric current may be needed.

In this way, by adjusting the amount of electric current flowing between the first electrode 402 and the second electrode 403, the hydrogen generating apparatus 400 can be made to generate the amount of hydrogen required by the connected fuel cell.

Among the factors listed above that determine the reaction rate for generating hydrogen at the second electrode 403 of the hydrogen generating apparatus 400, those factors other than the electrical resistance between the first electrode 402 and the second electrode 403 may be determined when constructing the hydrogen generating apparatus 400, and thus may not be easy to change.

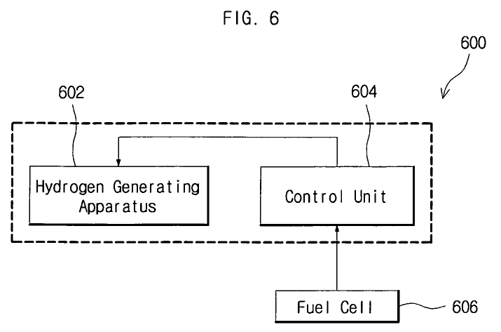

FIG. 6 is a block diagram of a fuel cell system according to an embodiment of the invention. As illustrated in the diagram, a hydrogen generating apparatus 602 according to an embodiment of the invention can include a control unit 604 between the wires (not shown) that connect the electrodes, to adjust the electrical resistance between the first electrode 402 and second electrode 403, and thereby control the amount of electrons flowing from the first electrode 402 to the second electrode 403. It is apparent that the first electrode 402 and second electrode 403 can be those electrodes illustrated in FIG. 4.

In other words, by changing the electrical resistance between the first electrode 402 and the second electrode 403 based on the above Equation 1, the magnitude of the electric current between the first electrode 402 and the second electrode 403 can be adjusted, making it possible to generate hydrogen by an amount required by the fuel cell 606.

In certain embodiments of the invention, the first electrode 402 can be made of a metal other than magnesium that has a relatively high ionization tendency, such as iron (Fe), aluminum (Al), zinc (Zn), etc. The second electrode 403 can be made of a metal such as platinum (Pt), copper (Cu), gold (Au), silver (Ag), iron (Fe), etc., that has a relatively lower ionization tendency than that of the metal used for the first electrode 402.

The control unit 604 can adjust the rate by which the electrons generated at the first electrode 402 by the electrochemical reactions are transferred to the second electrode 403. That is, the control unit 604 can adjust the electric current.

The control unit 604 can be inputted with the amount of power or amount of hydrogen required by the fuel cell 606, and if the required value is high, may increase the amount of electrons flowing from the first electrode 402 to the second electrode 403, or if the required value is low, may decrease the amount of electrons flowing from the first electrode 402 to the second electrode 403.

For example, the control unit 604 can include a variable resistance element, to adjust the electric current flowing between the first electrode 402 and second electrode 403 by varying the resistance value, or may include an on/off switch, to adjust the electric current flowing between the first electrode 402 and second electrode 403 by controlling the on/off timing.

The generated hydrogen can be transported through the hydrogen outlet 404 of the electrolyte bath 401 towards the fuel cell 606.

It is to be appreciated that aspects of the invention also provide a fuel cell power generation system 600 that includes the fuel cell 606 which is supplied with the hydrogen generated in the hydrogen generating apparatus 602 described above, and which converts the chemical energy of the hydrogen to electrical energy to produce a direct electrical current.

When the hydrogen generating apparatus provided in this embodiment is applied to a fuel cell, the apparatus for generating hydrogen can be implemented in a minute size, making it possible to provide a compact fuel cell. Furthermore, the gaps between electrodes may be reduced, and the number of electrodes may be increased, to enable a high efficiency in utilizing the electrodes.

As set forth above, a hydrogen generating apparatus based on a certain embodiment of the invention may include a reactor that can be processed with greater ease. In the hydrogen generating apparatus, the gaps between electrodes can be reduced, and the number of electrodes can be increased, to increase the efficiency of the electrodes.

Moreover, the circulation of water within the reactor can be facilitated, resulting in longer reaction times.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. As such, many embodiments other than those set forth above can be found in the appended claims.

What is claimed is:

1. A hydrogen generating apparatus comprising:
an electrolyte bath containing an electrolyte solution, the electrolyte bath comprising a first groove and a second groove formed in an inside surface thereof;
a first electrode coupled to the first groove with a predetermined distance from either end of the surface of the electrolyte bath, the first electrode configured to generate electrons; and
a second electrode coupled to the second groove with a predetermined distance from either end of the surface of the electrolyte bath, the second electrode configured to generate hydrogen using the electrons and the electrolyte solution.

2. The hydrogen generating apparatus of claim 1, wherein the first electrode and the second electrode are formed with a predetermined distance from an inside surface of the electrolyte bath opposite the first groove and the second groove.

3. The hydrogen generating apparatus of claim 1, further comprising:
a control unit configured to control an amount of electrons flowing from the first electrode to the second electrode.

4. The hydrogen generating apparatus of claim 1, further comprising:
a wire connected with the first electrode and the second electrode, the wire providing a path of travel for the electrons.

5. The hydrogen generating apparatus of claim 4, wherein connecting portions between the first and second electrodes and the wire are covered with an insulating material.

6. The hydrogen generating apparatus of claim 1, further comprising:
a hydrogen outlet coupled to an outer side of the electrolyte bath, the hydrogen outlet configured to discharge the hydrogen.

7. A fuel cell power generation system comprising:
a hydrogen generating apparatus, the hydrogen generating apparatus comprising:
an electrolyte bath containing an electrolyte solution, the electrolyte bath comprising a first groove and a second groove formed in an inside surface thereof;
a first electrode coupled to the first groove with a predetermined distance from either end of the surface of the electrolyte bath, the first electrode configured to generate electrons; and
a second electrode coupled to the second groove with a predetermined distance from either end of the surface of the electrolyte bath, the second electrode configured to generate hydrogen using the electrons and the electrolyte solution; and
a fuel cell configured to produce a direct electrical current by receiving the hydrogen generated by the hydrogen generating apparatus and converting chemical energy of the hydrogen into electrical energy.

8. The fuel cell power generation system of claim 7, wherein the first electrode and the second electrode are formed with a predetermined distance from an inside surface of the electrolyte bath opposite the first groove and the second groove.

9. The fuel cell power generation system of claim 7, further comprising:
a control unit configured to control an amount of electrons flowing from the first electrode to the second electrode.

10. The fuel cell power generation system of claim 7, wherein
a wire connected with the first electrode and the second electrode, the wire providing a path of travel for the electrons.

11. The fuel cell power generation system of claim 10, wherein connecting portions between the first and second electrodes and the wire are covered with an insulating material.

12. The fuel cell power generation system of claim 7, further comprising:
a hydrogen outlet coupled to an outer side of the electrolyte bath, the hydrogen outlet configured to discharge the hydrogen.
